(19) United States
(12) Patent Application Publication
(10) Pub. No.: US 2023/0276002 A1
(43) Pub. Date: Aug. 31, 2023

(54) Quality of Service (QoS) Influence in Edge Computing Application Enabler

(71) Applicant: Telefonaktiebolaget LM Ericsson (publ), Stockholm (SE)

(72) Inventor: Wenliang Xu, Shanghai (CN)

(21) Appl. No.: 18/014,271

(22) PCT Filed: Jul. 7, 2021
(86) PCT No.: PCT/EP2021/068864

§ 371 Date: Jan. 3, 2023

(30) Foreign Application Priority Data
Jul. 9, 2020 (WO) PCT/CN2020/101085

(51) Int. Cl. H04M 15/00; H04W 24/08

(52) U.S. Cl. CPC H04M 15/66; H04M 15/8016; H04W 24/08

(57) ABSTRACT

A dedicated Application Programming Interface (API) is provided. The edge consumer nodes (42) of an edge enabler node (44) in an Edge Data Network (EDN) (40) can use the API to influence the Quality of Service (QoS) for a service data flow, sponsor data traffic, and/or monitor the QoS of the data flow.

### TECHNICAL FIELD

This application relates generally to Edge Data Networks (EDN), and more particularly to influencing the Quality of Service (QoS) for a data flow in EDNs.

### BACKGROUND

Clauses 1 and 6 of 3GPP TS 23.558 v0.3.0, entitled “Architecture for enabling Edge Applications (EA),” provide an introduction to the Edge Computing Application Enabler. In general, this document discusses the application layer architecture, the procedures, and the information flows that are necessary for enabling edge applications over 3GPP networks. In more detail, however, the document specifies the architectural requirements for enabling edge applications, the application layer architecture required to fulfill the architecture requirements, and the procedures required to enable the deployment of edge applications. One area the document focuses on is minimizing the impact of the requirements to existing edge-based applications. This is so existing applications will not need major redevelopment efforts in order to enable their use at the EDN by User Equipments (UEs).

### SUMMARY

Embodiments of the present disclosure provide a dedicated Application Programming Interface (API) that the edge consumer nodes of an edge enabler node can use to influence the Quality of Service (QoS) for a service data flow, sponsor data traffic, and/or monitor the QoS of the data flow.

In a first aspect, the present disclosure provides a method for performing a Quality of Service (QoS) related service operation in an Edge Data Network (EDN). In this embodiment, the method is implemented at an edge enabler node in the EDN and comprises receiving a policy and charging request sent by an edge consumer node connected to the EDN, wherein the policy and charging request is a request to perform a QoS-related service operation on a data flow associated with a wireless device served by the edge consumer node, authorizing the edge consumer node for the requested QoS-related service operation on the data flow, and configuring one or more core network nodes associated with the one or both of the wireless device and the data flow to perform the requested QoS-related service operation on the data flow responsive to the edge consumer node being authorized.

In a second aspect, the present disclosure provides an edge enabler node in an Edge Data Network (EDN) configured to perform a Quality of Service (QoS) related service operation in the EDN. In this aspect, the edge enabler node comprises interface circuitry and processing circuitry operatively connected to the interface circuitry. The interface circuitry is configured to receive a policy and charging request sent by an edge consumer node connected to the EDN, wherein the policy and charging request is a request to perform a QoS-related service operation on a data flow associated with a wireless device served by the edge consumer node. The processing circuitry is configured to authorize the edge consumer node for the requested QoS-related service operation on the data flow, and configure one or more core network nodes associated with the one or both of the wireless device and the data flow to perform the requested QoS-related service operation on the data flow responsive to the edge consumer node being authorized.

In a third aspect, the present disclosure provides an edge enabler node in an Edge Data Network (EDN) for performing a Quality of Service (QoS) related service operation in the EDN. In this aspect, the edge enabler node is configured to receive a policy and charging request sent by an edge consumer node connected to the EDN, wherein the policy and charging request is a request to perform a QoS-related service operation on a data flow associated with a wireless device served by the edge consumer node, authorize the edge consumer node for the requested QoS-related service operation on the data flow, and configure one or more core network nodes associated with the one or both of the wireless device and the data flow to perform the requested QoS-related service operation on the data flow responsive to the edge consumer node being authorized.

In a fourth aspect, the present disclosure provides a non-transitory computer-readable storage medium having a computer program comprising executable instructions stored thereon that, when executed by a processing circuit of an edge enabler node in an Edge Data Network (EDN), causes edge enabler node to receive a policy and charging request sent by an edge consumer node connected to the EDN, wherein the policy and charging request is a request to perform a QoS-related service operation on a data flow associated with a wireless device served by the edge consumer node, authorize the edge consumer node for the requested QoS-related service operation on the data flow, and configure one or more core network nodes associated with the one or both of the wireless device and the data flow to perform the requested QoS-related service operation on the data flow responsive to the edge consumer node being authorized.

A fifth aspect of the present disclosure provides a computer program comprising executable instructions that, when executed by a processing circuit of an edge enabler node in an Edge Data Network (EDN), causes edge enabler node to perform the fourth aspect.

A sixth aspect of the disclosure comprises a carrier containing a computer program according to the fifth aspect. The carrier is one of an electronic signal, optical signal, radio signal, or a non-transitory computer readable storage medium.

### BRIEF DESCRIPTION OF THE DRAWINGS

FIG. 1 is a block diagram illustrating an architecture for enabling edge applications according to one embodiment of the present disclosure.

FIGS. 2A-2B are block diagrams illustrating respective Inter and Intra Edge Data Network (EDN) configurations for enabling edge applications according to one embodiment of the present disclosure.

FIG. 3 is a signaling diagram illustrating a method for enabling edge applications according to one embodiment of the present disclosure.

FIG. 4 is a schematic block diagram illustrating an edge enabler node configured according to one embodiment of the present disclosure.

FIG. 5 is a functional block diagram of an edge enabler node processing circuit and some functional components executed by the processing circuit according to one embodiment of the present disclosure.

### DETAILED DESCRIPTION

Embodiments of the present disclosure provide a dedicated Application Programming Interface (API) that the edge consumer nodes of an edge enabler node can use to influence the Quality of Service (QoS) for a service data flow, sponsor data traffic, and/or monitor the QoS of the data flow. Throughout the specification, the edge enabler node is referred to as an Edge Enabler Server (EES), and the consumer node is referred to as an Edge Application Server (EAS). However, those of ordinary skill in the art should readily appreciate that this is for ease of discussion only, and that the present disclosure is not so limited. In some embodiments, the edge consumer node may be an Edge Enabler Client (EEC) connected to the EDN, or in inter-EDN-based embodiments, another EES.

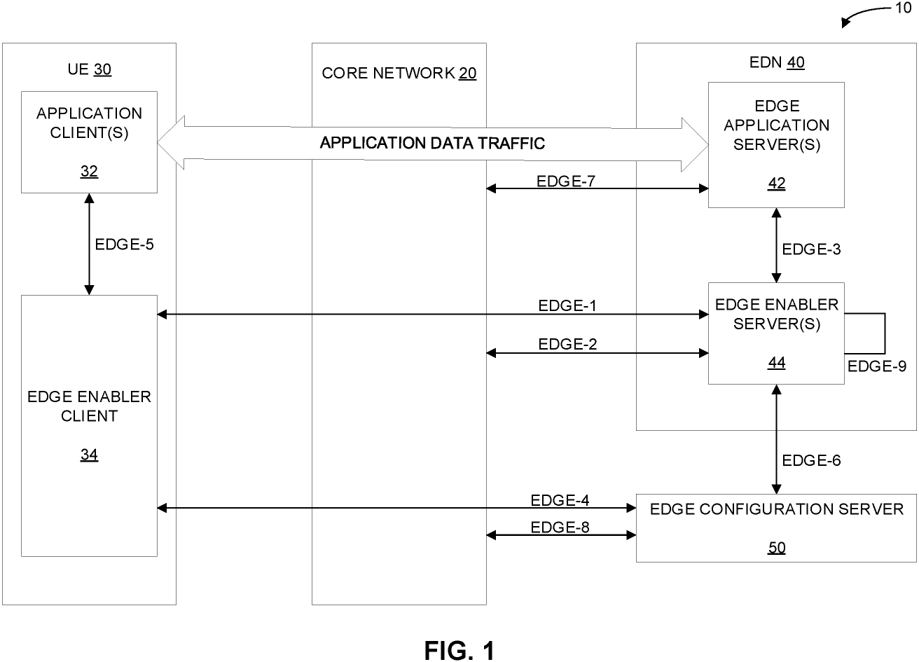

### FIG. 1

Turning now to the drawings, FIG. 1 is a block diagram illustrating an architecture for enabling edge applications according to one embodiment of the present disclosure. As seen in this figure, a communications system 10 comprises a core network (CN) communicatively connecting one or more mobile devices, such as User Equipments (UEs) 30, and an Edge Data Network (EDN) 40.

The functions of CN 20 are well-known in the art, and thus, not described in detail here. However, it is sufficient to understand that CN 20 comprises components configured to communicatively connect UE 30, via a radio access network (RAN) (not shown), to a third party network such as EDN 40. The components in CN 20 perform functions that are necessary for the service management, session management, and mobility management or UE 30, thereby making it possible for UE 30 to enjoy an end-to-end connection with EDN 40.

UE 30 is a wireless mobile device and comprises one or more Application Clients (ACs) 32 and an Edge Enabler Client (EEC) 34. The ACs 34 exchange application data traffic with an Edge Application Server (EAS) 42 in EDN 40. The EEC 34 connects to the ACs 32 via an EDGE-5 reference point and provides the functions that are needed to support ACs 34. For example, in this embodiment, the EEC 34 are configured to discover EASs 42 that are available in the EDN 40, and to retrieve and provision configuration information that facilitates the exchange of the application data traffic between ACs 32 and EAS 42.

The EDN 40 comprises the EAS 42 and an Edge Enabler Server (EES) 44. In some embodiments, an Edge Configuration Server (ECS) 50 is present and provides CN 20 and EEC 34 with configuration information that is associated with EDN 40. The EAS 42 is configured to provide application functions and services to UE 30 with the benefits of being in an edge network, such as EDN 40. As stated above, the ACs 32 communicatively connect to the EAS 42 and exchange application data traffic. Additionally, EAS 42 communicates with one or more of the components in CN 20 via an EDGE-7 reference point.

In some embodiments, the server functions of an application are available only at the EAS 42. In other embodiments, however, these functions are available at both the EAS 42 and an Application Server (AS) (not shown) in the Cloud. In these latter embodiments, the server functions at EAS 42 may be different than those at the cloud-based AS, and if so, the application traffic data between these entities is also different.

According to the present embodiments, the EAS 42 is configured to consume the capabilities of CN 20 in different ways. For example, provided that EAS 42 is a trusted entity, EAS 42 may directly invoke the CN 20 functions via the EDGE-7 reference point. In another example, EAS 42 may invoke the functions provided by CN 20 via EES 44. In yet another example, EAS 42 may invoke the CN 20 exposure functions.

The EES 44 is configured to provide the functions needed to support both the EASE 42 and the EEC 34. To accomplish these functions, the EES 44 is configured to provide provisioning and configuration information to the EAS 42 to enable the exchange of application data traffic between EAS 42 and ACs 32. Additionally, EES 34 is configured to provide information related to EAS 42 to the EEC 34, and support the Application Programming Interface (API) exposing functions, as well as the API invoker, that are specified in 3GPP TS 23.222 v. 15.2.0 Rel. 15 “LTE; 5G; Common API Framework for 3GPP Northbound APIs,” which is incorporated herein by reference.

As seen in FIG. 1, the ECS 50 communicatively interacts with CN 20 via an EDGE-8 reference point, and with the EEC 34 of UE 30 via an EDGE-4 reference point. The ECS 50 provides the supporting functions needed to facilitate EEC 34 establishing a connection with EES 44. According to the present embodiments, the ECS 50 is configured to provision EEC 34 with edge configuration information. Such information includes, for example, the information needed by EEC 34 to connect to EES 44 (e.g. service area information applicable to a Local Area Data Network -LADN), and the information needed by EEC 34 to establish a connection with EES 44 (e.g., a Uniform Resource Indicator – URI). Regardless of its functions, however, the ECS 50 may, in some embodiments, be deployed in a Mobile Network Operator (MNO) domain, or it may be deployed by a service provider in a third party domain.

As seen in FIG. 1, the different functional entities, which may be nodes, are connected via corresponding EDGE reference points. Two of these — EDGE-1 and EDGE-3 — are of specific interest.

The EDGE-1 reference point enables interactions between the EES 44 and the EEC 34. According to the present disclosure, the EDGE-1 reference point supports the following functions:
the registration and de-registration of the EEC 34 to/from the EES 44;
the retrieval and provisioning of the EAS 42 configuration information; and
the discovery of EASs 42 that are available in EDN 40.

The EDGE-3 reference point enables interactions between the EES 44 and the EAS 42. According to the present embodiments, the EDGE-3 reference point supports the following functions:
registration of Edge Application Servers with availability information (e.g. time constraints, location constraints);
de-registration of Edge Application Servers from the Edge Enabler Server; and
providing access to network capability information (e.g. location information).

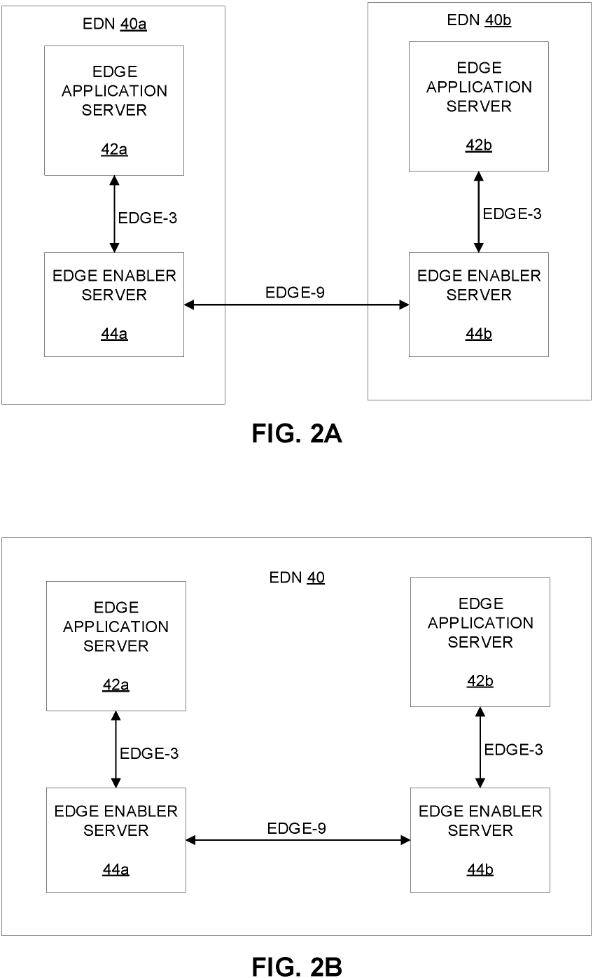

In addition to the EDGE-1 and EDGE-3 reference points, there is another reference point that connects different EESs 44 in different EDN configurations. For example, FIGS. 2A-2B are block diagrams illustrating Inter-EDN and Intra-EDN configurations, respectively, for enabling edge applications according to one embodiment of the present disclosure.

### FIGS. 2A-2B

As seen in the Inter-EDN configuration of FIG. 2A, two different EESs 44a, 44b are in two different EDNs 40a, 40b. In the Intra-EDN configuration of FIG. 2B, two different EESs 44a, 44b are in the same EDN 40. Regardless of the particular configuration, however, each EES 44a, 44b is connected to a corresponding EAS 42a, 42b via an EDGE-3 reference point, but are connected together via an EDGE-9 reference point that enables interactions between them.

It has been proposed to allow the EES 44 to influence the Quality of Service (QoS). To accomplish this, conventional solutions, such as those described in section 8.4.3 of TS 23.558 clause 8.4.3, propose providing QoS information (e.g., 5QI, ARP, bandwidth information) in the EAS registration procedure at EAS discovery. However, there are multiple reasons why EAS discovery is not the appropriate time to influence QoS. For example, one reason is that different “discovered” EASs may have different QoS requirements, and the EES has no way of knowing which EAS will be finally selected by the UE application. Another reason is that the IP address used by the UE to access the EES may not be the same IP address used to access the selected EAS.

To address these issues, embodiments of the present disclosure provide a dedicated API that consumer nodes in an edge network (e.g., EAS 42) can use to influence the QoS for a service data flow, sponsor data traffic, and/or monitor the QoS of the data flow.

The present embodiments provide benefits and advantages over conventional systems. For example, it is more desirable for the EAS 42 to interact separately with an edge enabling layer to influence the QoS for the service data flow, sponsor the traffic and/or monitor the QoS with the following add-on values. Therefore, if the EAS cannot directly access the 3GPP network, it can use the Policy and Charging capability exposure service provided by the EES via the EDGE-3 reference point.

Further, in some cases, the EES-provided Policy and Charging capability exposure service may be associated with different Application Function (AF) events (e.g. usage reporting). Therefore, another advantage associated with using the EES-provided service is that it allows advanced control for event reporting. For example, the EES can support the “one time reporting” event reporting mode in the EES by unsubscribing the corresponding Policy Control Function/Network Exposure Function (PCF/NEF) event once the first report is received. The EES can also control the maximum number of reports and the reporting period so as to provide an enhanced version of Policy and Charging exposure with more event reporting control.

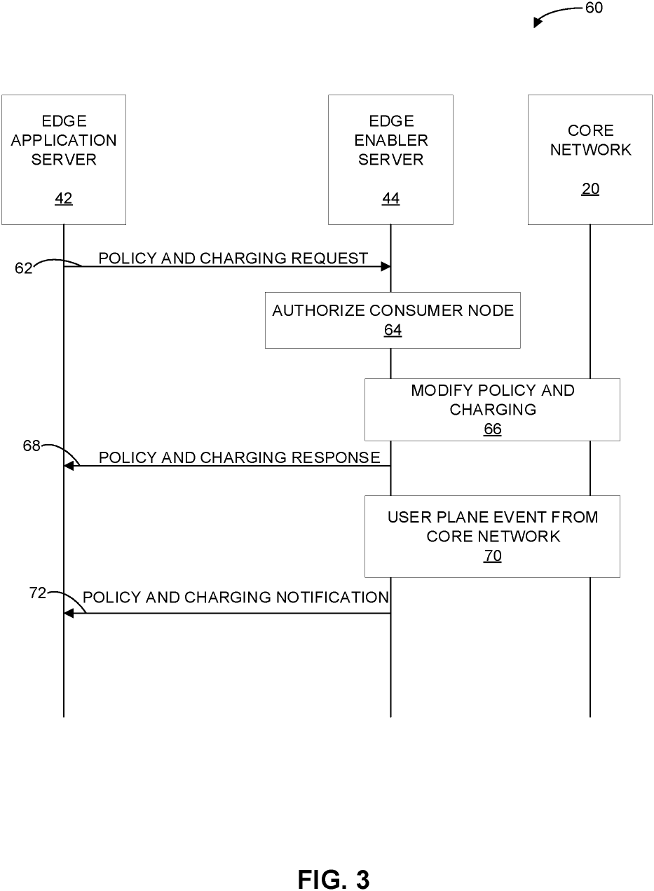

### FIG. 3

FIG. 3 is a signaling diagram illustrating a method 60 for enabling edge applications according to one embodiment of the present disclosure. In general, the EES 44 provides the QoS capability exposure service in the form of an API to the EAS 42. In more detail, FIG. 3 illustrates the Policy and Charging operations between the EAS 42 and the EES 44 for managing the policy and charging used for traffic between the ACs 32 and EAS 42. With this service, the EES 44 is able to modify the QoS of a service data flow, monitor the QoS, and the like.

As seen in FIG. 3, method 60 begins with the EAS 42 sending a Policy and Charging request to the EES 44 (line 62). The request may be, as described in more detail below, a CREATE request, an UPDATE request, or a DELETE request. Regardless, in this embodiment, the Policy and Charging request includes the IP address of UE 20 and a description of the IP flow. In embodiments where the QoS is to be changed, the request also includes a QoS reference, and in addition, a list of alternative QoS references order of their priority. In embodiments where the request is to monitor a QoS, the request includes the QoS target to be monitored (e.g., a QoS parameter on the Downlink (DL), on the Uplink (UL), or a roundtrip packet delay). Additionally, EAS 42 may request usage monitoring for sponsored data connectivity. If such monitoring is requested, the Policy and Charging request also includes information that specifies the reporting frequency.

Upon receipt of the Policy and Charging request, the EES 44 verifies that the ESA 42 is authorized for the requested operation (box 64). If the EES 44 cannot authorize the requesting EAS 42, EES 44 generates and sends a Policy and Charging rejection response to the EAS 42 (line 68). However, if EES 44 can authorize EAS 42 for the requested operation, EES 42 interacts with the CN 20 (box 66) to set up the required QoS, and to apply QoS monitoring as described in 3GPP TS 23.501 v. 16.4.0 “System architecture for the 5G System (5GS)” and 3GPP TS 23.502 v.16.4.0 “Procedures for the 5G System (5GS),” both of which are incorporated herein by reference in their entirety. The EES 44 then generates and sends a Policy and Charging response to the EAS 42 (line 68).

Thereafter, the EES 44 receives a user plane event of the UE 20 (e.g. a QoS monitoring report) (box 70). In response, the EES 44 sends a Policy and Charging notification including the received user plane event to the EAS 42 (box 72).

Accordingly, the present disclosure provides a method for performing a Quality of Service (QoS) related service operation in an Edge Data Network (EDN). In this embodiment, the method is implemented at an edge enabler node (e.g., the EES 44) in the EDN 40 and comprises receiving a policy and charging request sent by an edge consumer node (e.g., the EAS 42) connected to the EDN 40. The policy and charging request is a request to perform a QoS-related service operation on a data flow associated with a wireless device served by the edge consumer node. The edge enabler node then authorizes the edge consumer node for the requested QoS-related service operation on the data flow, and if authorized, configures one or more core network nodes associated with the one or both of the wireless device and the data flow to perform the requested QoS-related service operation on the data flow.

In some embodiments of method 60, the policy and charging request comprises an IP address of the wireless device served by the edge consumer node, an IP flow description describing the data flow associated with the wireless device served by the edge consumer node.

In some embodiments, the requested QoS-related service operation comprises a request to modify a QoS associated with the data flow.

In some embodiments, the policy and charging request comprises a QoS reference identifying pre-determined QoS information and a list of alternative QoS references in a prioritized order.

In some embodiments, the requested QoS-related service operation comprises a request to monitor a QoS associated with the data flow.

In some embodiments, the policy and charging request indicates a QoS target to be monitored. The QoS target comprises a QoS parameter associated with one of an uplink (UL), a downlink (DL), and a roundtrip packet delay.

In some embodiments, the policy and charging request indicates usage monitoring for a data flow sponsored by a third party, the usage monitoring comprising one of time, an amount of data in the data flow sent over an UL, and an amount of data in the data flow sent over a DL.

In some embodiments, the requested QoS-related service operation comprises a request to monitor a user plane event.

In some embodiments, the policy and charging request indicates reporting information for the user plane event, and a reporting frequency with which the user plane event is to be reported.

In some embodiments, the policy and charging response comprises at least one of an indication that indicates whether the policy and charging request succeeded or failed and a context ID associated with the policy and charging request.

In some embodiments of method 60, the request message is a policy and charging update request from the edge consumer node. In these embodiments, the policy and charging update request is a request to update the received policy and charging request and includes the context ID associated with the received policy and charging request.

In some embodiments, the response message is a policy and charging update response sent to the edge consumer node indicating whether the policy and charging update request succeeded or failed.

In some embodiments of method 60, the request message is a policy and charging delete request from the edge consumer node, wherein the policy and charging delete request is a request to delete the previously received policy and charging request and includes the context ID associated with the previously received policy and charging request.

In some embodiments, the response message is a policy and charging delete response to the edge consumer node indicating whether the policy and charging delete request succeeded or failed.

In some embodiments, configuring one or more core network nodes associated with the one or both of the wireless device and the data flow to perform the requested QoS-related service operation on the data flow comprises sending the policy and charging notification request to the edge consumer node indicating the user plane event to monitor and the context ID associated with the received policy and charging request.

In some embodiments, the user plane event comprises one of usage reporting for sponsored data connectivity, service flow deactivation, resource allocation outcome, an indication that the QoS target can no longer satisfied, or can again be satisfied, and QoS monitoring parameters.

In some embodiments, a first user plane event is received, wherein the first user plane event is associated with the QoS-related service operation. Additionally, in these embodiment, the policy and charging notification is sent to the edge consumer node, wherein the policy and charging notification comprises the first user plane event.

In some embodiments, the edge enabler node is an Edge Enabler Server (EES).

In some embodiments, the edge consumer node is one of an Edge Application Server (EAS), an Edge Enabler Client (EEC), and another Edge Enabler Server (EES).

In some embodiments, the core network node comprises one of a Network Exposure Function (NEF), a Policy Charging Function (PCF), a Service Capability Exposure Function (SCEF), and a Policy and Charging Rules Function (PCRF).

Table 1 below specifies the service operations of the API for the Policy and Charging according to one embodiment of the present disclosure. As seen in Table 1, the API facilitates a CREATE operation, an UPDATE operation, a DELETE operation, and a NOTIFY operation. The parameters for each of these operations are detailed below, but are communicated between the EES 44 and the EAS 42 via the EDGE-3 reference point.

TABLE 1

Policy and Charging API

| | | | |
|---|---|---|---|
| Service Name | Service Operations | Operation Semantics | Consumer(s) |
| EDGE3_Policy_and_Charging_API | Create | Request/Response | EAS |
| | Update | Request/Response | EAS |
| | Delete | Request/Response | EAS |
| | Notify | Subscribe/Notify | EAS |

### Policy and Charging CREATE Request

The EAS 42 uses the CREATE operation to create a Policy and Charging request to monitor the application data traffic, and may also use the CREATE operation to subscribe to receive one or more user plane events related to the user plane traffic. The parameters comprising the Policy and Charging Request message are detailed in Table 2.

TABLE 2

| | | |
|---|---|---|
| Information element | Status (Mandatory /Optional) | Description |
| UE IP address | M | The UE IP address |
| IP flow description | M | The IP flow description for the application traffic |
| QoS reference | M | A QoS reference referring to the preconfigured QoS information in EES or 3GPP Core Network. |
| A list of alternative QoS references | O | A list of alternative QoS references. |
| Event list | O | A list of associated events. |
| Event reporting information | O | Event Reporting Information as specified in table 4.15.1-1 of 3GPP TS 23.502, e.g. event reporting mode. |
| Event specific data | O | For usage monitoring: the sponsoring information (sponsor ID, ASP ID). For QoS monitoring: Target of monitoring (DL, UL or roundtrip packet delay). |
| Frequency of Reporting | O | The frequency with which the event is reported (e.g., specified by a threshold minimum waiting time) as described in clause 6.1.3.21 of 3GPP TS 23.503 v. 16.4.1 “Policy and charging control framework for the 5G System (5GS); Stage 2” |
| Notification Target Address | M | Notification Target Address of the EAS where the notification is to be sent by the EES |

### Policy and Charging CREATE Response

The EES 44 uses the CREATE Response to indicate to the EAS 42 whether the requested operation succeeded or failed. The parameters comprising the Policy and Charging Response message are detailed in Table 3.

TABLE 3

| | | |
|---|---|---|
| Information element | Status (Mandatory /Optional) | Description |
| Result | M | Indicates whether the operation is successful or failure |
| Context ID (See Note) | O | Context identifier corresponding to the information stored for the request |

Note: The Information Element (IE) that has the Context ID is included when the Result indicates success.

### Policy and Charging UPDATE Request

The EAS 42 uses the UPDATE operation to update the Policy and Charging for the application data traffic subject to the QoS. The parameters comprising the Policy and Charging Update message are detailed in Table 4.

TABLE 4

| | | |
|---|---|---|
| Information element | Status (Mandatory /Optional) | Description |
| Context ID | M | Context identifier corresponding to the information stored for the request |
| QoS reference | O | A QoS reference referring to the preconfigured QoS information in EES or 3GPP Core Network. |
| A list of alternative QoS references | O | A list of alternative QoS references. |
| Event list | O | A list of associated events. |
| Event reporting information | O | Event Reporting Information as specified in table 4.15.1-1 of 3GPP TS 23.502, e.g. event reporting mode. |
| Event specific data | O | For usage monitoring: the sponsoring information (sponsor ID, ASP ID). For QoS monitoring: Target of monitoring (DL, UL or roundtrip packet delay. |
| Frequency of reporting | O | The frequency with which the event is reported (e.g., specified by a threshold minimum waiting time) as described in clause 6.1.3.21 of 3GPP TS 23.503 v. 16.4.1 |

### Policy and Charging UPDATE Response

The EES 44 uses the UPDATE Response to indicate to the EAS 42 whether the requested operation succeeded or failed. The parameters comprising the Policy and Charging Response message are detailed in Table 5.

TABLE 5

| | | |
|---|---|---|
| Information element | Status (Mandatory /Optional) | Description |
| Result | M | Indicates whether the operation is successful or failure |

### Policy and Charging DELETE Request

The EAS 42 uses the DELETE operation to delete the current Policy and Charging for the application data traffic subject to the QoS. The parameters comprising the Policy and Charging Delete message are detailed in Table 6.

TABLE 6

| | | |
|---|---|---|
| Information element | Status (Mandatory /Optional) | Description |
| Context ID | M | Context identifier corresponding to the information stored for the request |

### Policy and Charging DELETE Response

The EES 44 uses the DELETE Response to indicate to the EAS 42 whether the requested operation succeeded or failed. The parameters comprising the Policy and Charging Response message are detailed in Table 7.

TABLE 7

| | | |
|---|---|---|
| Information element | Status (Mandatory /Optional) | Description |
| Result | M | Indicates whether the operation is successful or failure |

### Policy and Charging NOTIFICATION Request

The EES 44 uses the NOTIFICATION operation to indicate one of the enumerated user plane events to the EAS 42. The parameters comprising the Policy and Charging Notify message are detailed in Table 8.

TABLE 8

| | | |
|---|---|---|
| Information element | Status (Mandatory /Optional) | Description |
| Context ID | M | Context identifier corresponding to the information stored in the EES during initial request of policy and charging. |
| Event report | O | Event reporting information as specified in clause 6.1.3.1.8 of 3GPP TS 23.503 v. 16.4.1 (See Note) |

Note: The following events are applicable: • Reporting Usage for Sponsored Data Connectivity • Service Data Flow deactivation • Resource allocation outcome • QoS targets can no longer (or can again) be fulfilled • QoS Monitoring parameters

An apparatus can perform any of the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

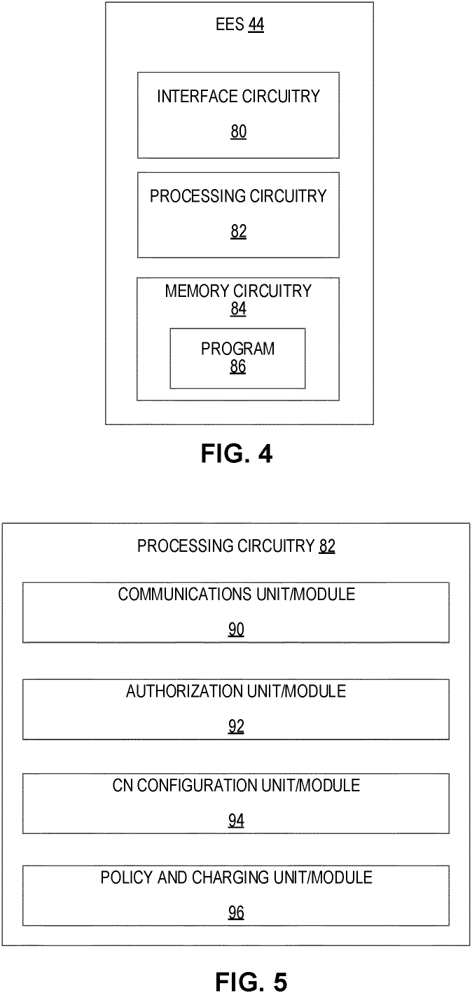

### FIG. 4

FIG. 4 is a schematic block diagram illustrating an edge enabler node (e.g., EES 44) configured according to one embodiment of the present disclosure. As seen in FIG. 4, EES 44 comprises interface circuitry 80, processing circuitry 82, and memory circuitry 84.

The interface circuitry 80 comprises network interface circuitry for communicating with other network nodes in the EDN 40 and the CN 20, as well as with the UE 30 and the ECS 50.

Processing circuitry 82 controls the overall operation of EES 44 and is configured to perform method 60 illustrated in FIG. 3. The processing circuitry 82 may comprise one or more microprocessors, hardware, firmware, or a combination thereof.

Memory circuitry 84 comprises both volatile and non-volatile memory for storing computer program code and data needed by the processing circuitry 82 for operation. Memory circuitry 84 may comprise any tangible, non-transitory computer-readable storage medium for storing data including electronic, magnetic, optical, electromagnetic, or semiconductor data storage. Memory circuitry 84 stores a computer program 86 comprising executable instructions that configure the processing circuitry 82 to implement method 60 according to FIG. 3. A computer program in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 86 for configuring the processing circuitry 82 as herein described may be stored in a removable memory, such as a portable compact disc, portable digital video disc, or other removable media. The computer program 86 may also be embodied in a carrier such as an electronic signal, optical signal, radio signal, or computer readable storage medium.

### FIG. 5

FIG. 5 is a functional block diagram of an edge enabler node (e.g., EES 44) processing circuitry 82 and some functional components executed by the processing circuitry 82 according to one embodiment of the present disclosure. As seen in FIG. 5, the processing circuitry 82 of EES 44 comprises a communications unit/module 90, an authorization unit/module 92, a CN configuration unit/module 94, and a policy and charging unit/module 96.

The communications unit/module 90 is configured to communicate the policy and charging messages with the EAS 42, the EEC 24, and other EESs 44, as previously described. The authorization unit/module 92 is configured to authorize the EAS 42, or other edge consumer node, that sent the policy and charging request received by EES 44, as previously described. The CN configuration unit/module 94 is configured to interact with CN 20 to set up a required QoS, and to apply QoS monitoring, as requested by the EAS 42 and as previously described. The policy and charging unit/module 96 is configured to generate and send the policy and charging response messages to the EAS 42 and/or other consumer edge nodes. In cases where the EES 44 functions as an edge consumer node, the policy and charging unit/module 96 is configured to generate and send the policy and charging request messages to the EES 44.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

### Some Embodiments

Some embodiments described above may be summarized in the following enumerated manner:

1. A method (60) for performing a Quality of Service (QoS) related service operation in an Edge Data Network (EDN) (40), the method implemented at an edge enabler node (44) in the EDN and comprising:
receiving (62) a policy and charging request sent by an edge consumer node (42) connected to the EDN, wherein the policy and charging request is a request to perform a QoS-related service operation on a data flow associated with a wireless device served by the edge consumer node;
authorizing (64) the edge consumer node for the requested QoS-related service operation on the data flow; and
configuring (66) one or more core network nodes associated with the one or both of the wireless device and the data flow to perform the requested QoS-related service operation on the data flow responsive to the edge consumer node being authorized.

2. The method of embodiment 1 wherein the policy and charging request comprises:
an IP address of the wireless device served by the edge consumer node; and
an IP flow description describing the data flow associated with the wireless device served by the edge consumer node.

3. The method of embodiment 1 or 2 wherein the requested QoS-related service operation comprises a request to modify a QoS associated with the data flow.

4. The method of embodiment 3 wherein the policy and charging request comprises:
a QoS reference identifying pre-determined QoS information; and
a list of alternative QoS references in a prioritized order.

5. The method of embodiment 1 or 2 wherein the requested QoS-related service operation comprises a request to monitor a QoS associated with the data flow.

6. The method of embodiment 5 wherein the policy and charging request indicates a QoS target to be monitored, the QoS target comprising a QoS parameter associated with one of:
an uplink (UL);
a downlink (DL); and
a roundtrip packet delay.

7. The method of embodiment 5 wherein the policy and charging request indicates usage monitoring for a data flow sponsored by a third party, the usage monitoring comprising one of:
time;
an amount of data in the data flow sent over an UL; and
an amount of data in the data flow sent over a DL.

8. The method of embodiment 1 or 2 wherein the requested QoS-related service operation comprises a request to monitor a user plane event.

9. The method of embodiment 8 wherein the policy and charging request indicates:
reporting information for the user plane event; and
a reporting frequency with which the user plane event is to be reported.

10. The method of any of the preceding embodiments further comprising sending (68) a policy and charging response to the edge consumer node, wherein the policy and charging response comprises at least one of:
an indication that indicates whether the policy and charging request succeeded or failed; and
a context ID associated with the policy and charging request.

11. The method of any of the preceding embodiments wherein the policy and charging request is a policy and charging update request from the edge consumer node requesting to update a previously received policy and charging request and includes the context ID associated with the previously received policy and charging request.

12. The method of embodiment 11 wherein the policy and charging response comprises a policy and charging update response sent to the edge consumer node indicating whether the policy and charging update request succeeded or failed.

13. The method of any of embodiment 1-10 wherein the policy and charging request is a policy and charging delete request from the edge consumer node requesting to delete a previously received policy and charging request and includes the context ID associated with the previously received policy and charging request.

14. The method of embodiment 13 wherein the policy and charging response comprises a policy and charging delete response to the edge consumer node indicating whether the policy and charging delete request succeeded or failed.

15. The method of any of the preceding embodiments wherein configuring one or more core network nodes associated with the one or both of the wireless device and the data flow to perform the requested QoS-related service operation on the data flow comprises sending (70) a policy and charging notification request to the edge consumer node indicating the user plane event to monitor and the context ID associated with the received policy and charging request.

16. The method of embodiment 15 wherein the user plane event comprises one of:
usage reporting for sponsored data connectivity;
service flow deactivation;
resource allocation outcome;
an indication that the QoS target can no longer satisfied, or can again be satisfied; and
QoS monitoring parameters.

17. The method of any of the preceding embodiments further comprising:
receiving a first user plane event, wherein the first user plane event is associated with the QoS-related service operation; and
sending a policy and charging notification to the edge consumer node, wherein the policy and charging notification comprises the first user plane event.

18. The method of any of the preceding embodiments wherein the edge enabler node is an Edge Enabler Server (EES).

19. The method of any of the preceding embodiments wherein the edge consumer node is one of:
an Edge Application Server (EAS);
an Edge Enabler Client (EEC); and
another Edge Enabler Server (EES).

20. The method of any of the preceding embodiments wherein the core network node comprises one of:
a Network Exposure Function (NEF);
a Policy Charging Function (PCF);
a Service Capability Exposure Function (SCEF); and
a Policy and Charging Rules Function (PCRF).

21. An edge enabler node (44) in an Edge Data Network (EDN) (40) configured to perform a Quality of Service (QoS) related service operation in the EDN, the edge enabler node comprising:
interface circuitry (80) configured to receive a policy and charging request sent by an edge consumer node connected to the EDN, wherein the policy and charging request is a request to perform a QoS-related service operation on a data flow associated with a wireless device served by the edge consumer node; and
processing circuitry (82) operatively connected to the interface circuitry and configured to:
   authorize the edge consumer node for the requested QoS-related service operation on the data flow; and
   configure one or more core network nodes associated with the one or both of the wireless device and the data flow to perform the requested QoS-related service operation on the data flow responsive to the edge consumer node being authorized.

22. The edge enabler node of embodiment 20 wherein the processing circuitry is further configured to perform the method of any of embodiment 2-20.

23. An edge enabler node (44) in an Edge Data Network (EDN) (40) for performing a Quality of Service (QoS) related service operation in the EDN, the edge enabler node being configured to:
receive (62) a policy and charging request sent by an edge consumer node (42) connected to the EDN, wherein the policy and charging request is a request to perform a QoS-related service operation on a data flow associated with a wireless device served by the edge consumer node;
authorize (64) the edge consumer node for the requested QoS-related service operation on the data flow; and
configure (66) one or more core network nodes associated with the one or both of the wireless device and the data flow to perform the requested QoS-related service operation on the data flow responsive to the edge consumer node being authorized.

24. A non-transitory computer-readable storage medium (84) having a computer program (86) comprising executable instructions stored thereon that, when executed by a processing circuit (82) of an edge enabler node (44) in an Edge Data Network (EDN) (40), causes the edge enabler node to:
receive (62) a policy and charging request sent by an edge consumer node (42) connected to the EDN, wherein the policy and charging request is a request to perform a QoS-related service operation on a data flow associated with a wireless device served by the edge consumer node;
authorize (64) the edge consumer node for the requested QoS-related service operation on the data flow; and
configure (66) one or more core network nodes associated with the one or both of the wireless device and the data flow to perform the requested QoS-related service operation on the data flow responsive to the edge consumer node being authorized.

25. A computer program (86) comprising executable instructions that, when executed by a processing circuit (82) of an edge enabler node (44) in an Edge Data Network (EDN) (40), causes edge enabler node to perform the method of any of embodiment 1 - 20.

26. A carrier comprising a computer program of embodiment 25, wherein the carrier is one of an electronic signal, optical signal, radio signal, or computer readable storage medium.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1-23. (canceled)

24. A method for performing a Quality of Service (QoS) related service operation in an Edge Data Network (EDN), the method implemented at an edge enabler node in the EDN and comprising:
receiving a policy and charging request sent by an edge consumer node connected to the EDN, wherein the policy and charging request is a request to perform a QoS-related service operation on a data flow associated with a wireless device served by the edge consumer node;
authorizing the edge consumer node for the requested QoS-related service operation on the data flow; and
providing one or more core network nodes associated with the one or both of the wireless device and the data flow to perform the requested QoS-related service operation on the data flow responsive to the edge consumer node being authorized.

25. The method of claim 24 wherein the policy and charging request comprises:
an IP address of the wireless device served by the edge consumer node; and
an IP flow description describing the data flow associated with the wireless device served by the edge consumer node.

26. The method of claim 24 wherein the requested QoS-related service operation comprises a request to modify a QoS associated with the data flow.

27. The method of claim 26 wherein the policy and charging request comprises:
a QoS reference identifying pre-determined QoS information; and
a list of alternative QoS references in a prioritized order.

28. The method of claim 24 wherein the requested QoS-related service operation comprises a request to monitor a QoS associated with the data flow.

29. The method of claim 28 wherein the policy and charging request indicates a QoS target to be monitored, the QoS target comprising a QoS parameter associated with one of:
an uplink (UL);
a downlink (DL); and
a roundtrip packet delay.

30. The method of claim 28 wherein the policy and charging request indicates usage monitoring for a data flow sponsored by a third party, the usage monitoring comprising one of:
time;
an amount of data in the data flow sent over an UL; and
an amount of data in the data flow sent over a DL.

31. The method of claim 24 wherein the requested QoS-related service operation comprises a request to monitor a user plane event.

32. The method of claim 31 wherein the policy and charging request indicates:
reporting information for the user plane event; and
a reporting frequency with which the user plane event is to be reported.

33. The method of claim 24 further comprising sending a policy and charging response to the edge consumer node, wherein the policy and charging response comprises at least one of:
an indication that indicates whether the policy and charging request succeeded or failed; and
a context ID associated with the policy and charging request.

34. The method of claim 24 wherein the policy and charging request is a policy and charging update request from the edge consumer node requesting to update a previously received policy and charging request and includes the context ID associated with the previously received policy and charging request.

35. The method of claim 34 wherein the policy and charging response comprises a policy and charging update response sent to the edge consumer node indicating whether the policy and charging update request succeeded or failed.

36. The method of claim 24 wherein the policy and charging request is a policy and charging delete request from the edge consumer node requesting to delete a previously received policy and charging request and includes the context ID associated with the previously received policy and charging request.

37. The method of claim 36 wherein the policy and charging response comprises a policy and charging delete response to the edge consumer node indicating whether the policy and charging delete request succeeded or failed.

38. The method of claim 24 wherein providing one or more core network nodes associated with the one or both of the wireless device and the data flow to perform the requested QoS-related service operation on the data flow comprises sending a policy and charging notification request to the edge consumer node indicating the user plane event to monitor and the context ID associated with the received policy and charging request.

39. The method of claim 38 wherein the user plane event comprises one of:
usage reporting for sponsored data connectivity;
service flow deactivation;
resource allocation outcome;
an indication that the QoS target can no longer satisfied, or can again be satisfied; and
QoS monitoring parameters.

40. The method of claim 24 further comprising:
receiving a first user plane event, wherein the first user plane event is associated with the QoS-related service operation; and
sending a policy and charging notification to the edge consumer node, wherein the policy and charging notification comprises the first user plane event.

41. An edge enabler node in an Edge Data Network (EDN) configured to perform a Quality of Service (QoS) related service operation in the EDN, the edge enabler node comprising:
interface circuitry configured to receive a policy and charging request sent by an edge consumer node connected to the EDN, wherein the policy and charging request is a request to perform a QoS-related service operation on a data flow associated with a wireless device served by the edge consumer node; and
processing circuitry operatively connected to the interface circuitry and configured to:
authorize the edge consumer node for the requested QoS-related service operation on the data flow; and
provide one or more core network nodes associated with the one or both of the wireless device and the data flow to perform the requested QoS-related service operation on the data flow responsive to the edge consumer node being authorized.

42. A non-transitory computer-readable storage medium having a computer program comprising executable instructions stored thereon that, when executed by a processing circuit of an edge enabler node in an Edge Data Network (EDN), causes the edge enabler node to:
receive a policy and charging request sent by an edge consumer node connected to the EDN, wherein the policy and charging request is a request to perform a QoS-related service operation on a data flow associated with a wireless device served by the edge consumer node;
authorize the edge consumer node for the requested QoS-related service operation on the data flow; and
provide one or more core network nodes associated with the one or both of the wireless device and the data flow to perform the requested QoS-related service operation on the data flow responsive to the edge consumer node being authorized.
